(19) United States
(12) Patent Application Publication
(10) Pub. No.: US 2002/0114477 A1
(43) Pub. Date: Aug. 22, 2002

(54) Directional optical mircophone

(76) Inventors: Alexander Paritsky, Modiin (IL); Alexander Kots, Ashdod (IL); Hachiro Sato, Tokyo (JP); Okihiro Kobayashi, Tokyo (JP); Nobuhiro Miyahara, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/882,742

(22) Filed: Jun. 15, 2001

(30) Foreign Application Priority Data
Oct. 15, 1999 (JP) 11-294222

(51) Int. Cl. H04R 25/00

(52) U.S. Cl. 381/172

(57) ABSTRACT

An optical microphone having enhanced sensitivity only along a specified axis and free from the effect of ambient noises. The optical microphone comprises a diaphragm (2) vibrating with sound pressure, a light source (3) for irradiating the diaphragm (2) with a light beam, a photodetector (5) for receiving a fraction of the light reflected from the diaphragm (2) and outputting a signal corresponding to the vibration of the diaphragm (2), and a light source driving circuit (13) for driving the light source (3) by supplying a specified current. The optical microphone is additionally provided with a negative feedback circuit (100) for supplying the light source driving circuit (13) with a part of the output signal from the photodetector (5) as a negative feedback signal.

### CROSS-REFERENCES TO RELATED APPLICATIONS

International Publication No.: WO 01/28281

International Application No.: PCT/JP00/07165

International Application Date: Oct. 16, 2000 (16.10.2000)

Priority No.: Japanese Patent Application No.11-294222

Priority Date: Oct. 15, 1999 (15.10.1999) JP

### BACKGROUND OF THE INVENTION

1. Technical Field

This invention relates in an optical microphone device that converts the oscillation of a diaphragm to an electric signal by using light, and it is related to an optical microphone device which directivity can be varied.

2. Description of the Related Art

FIG. 8 is a sectional view that shows a point part configuration of a head part of the conventional optical microphone device. Inside the microphone head 1, a diaphragm that oscillates by the sound pressure is provided, and a surface 2a that a sound wave hits is exposed in the outside to receive a sound wave 7. The space inside of the head 1 is divided to a portion facing a surface 2a and another portion facing an opposite surface 2b. In the portion facing the surface 2b, a light source 3 such as an LED irradiating a light beam L in the surface 2b of the diaphragm 2 from a slant, a lens 4 to make the light beam L a predetermined beam diameter, a photodetector 5 which receives a reflection light L1 reflected in the surface 2b, and a lens 6 to zoom a displacement of an optical path of the reflection light L1 caused by the oscillation of the diaphragm 2 are provided.

In this structure, a sound wave 7 hits the diaphragm 2, a signal corresponding to a receiving position of the receiving surface 5a of the reflection light L1 is outputted from the photodetector 5. Therefore, the oscillation of the diaphragm 2 can be detected by non-contact with the diaphragm 2 to convert to an electric signal and there is no need to set up oscillatory detection on the diaphragm 2 any more. Moreover, the oscillatory part may be formed in lightweight and it can follow the variation of the weak sound wave.

The conventional optical microphone device has the directional characteristics that it has optimum sensitivity in the direction that is vertical to the diaphragm. However, this directional characteristics pattern was fixed and this pattern may not be varied. On the other hand, a microphone that may have a strong directivity and decrease outside noise from other directions is required.

As directional characteristics may not be varied in the conventional optical microphone device shown in FIG. 8, there was a problem that the use of the conventional microphone was limited. It is an object of this invention to solve the above-mentioned problem and to provide an optical microphone device may vary directional characteristics, and may form a sharp directivity beam pattern in the predetermined direction.

### BRIEF SUMMARY OF THE INVENTION

To solve the above-mentioned problem, the optical microphone device comprises: a diaphragm which oscillates by a sound pressure; a light source that irradiates a light beam in the diaphragm; a photo detector which receives a reflection light of the light beam irradiated in the diaphragm and which outputs a signal coping with the oscillation of the diaphragm; a light source drive circuit for driving to supply the light source with a predetermined electric current; and a negative feedback circuit that supplies a part of the signal outputted from the photodetector with the light source drive circuit as a negative feedback signal.

In the optical microphone device of this invention, the negative feedback circuit comprises a comparator that an output terminal is connected to a control terminal of the light source drive circuit and that a non-reverse input terminal is connected to the predetermined potential point; and a small signal amplification circuit that amplifies the signal from the photodetector when the signal level is less than a predetermined level, and the amplification degree grows bigger along with the signal level becomes lower; and wherein the output of the small signal amplification circuit is supplied to the reverse input terminal of the comparator.

In the above optical microphone device of this invention, the output of the small signal amplification circuit can be supplied to the reverse input terminal of the comparator through a filter circuit that allows the output in a predetermined frequency range to pass. Furthermore, in the above optical microphone device of this invention, further comprises a gain of negative feedback variable means that varies the gain of negative feedback of the above negative feedback signal.

### BRIEF DESCRIPTION OF THE DRAWINGS

FIG. 1 shows a block diagram that shows a configuration of an optical microphone device in an embodiment of this invention. FIG. 2 shows a circuit diagram that shows an example of a small signal amplification circuit used in this invention. FIG. 3 shows directivity characteristics of a sensitivity of an optical microphone device in this invention. FIG. 4 shows a figure to explain the microphone principle of a velocity type microphone. FIG. 5 shows a directivity response pattern of the sensitivity that a usual optical microphone can achieve. FIG. 6 shows a figure to explain an actuation principle of the small signal amplification circuit used for this invention. FIG. 7 shows a performance characteristics of circuit shown in FIG. 1. FIG. 8 shows a configuration of a part of a head of the conventional optical microphone device. In these figures, 2 is diaphragm, 3 is light source, 5 is photodetector, 10 is small signal amplification circuit, 12 is comparator, 13 is light source drive circuit, 14 is norm power source, 20 is amplifier and 100 is negative feedback circuit.

### DESCRIPTION OF THE PREFERRED EMBODIMENTS

First, a fundamental principle of an optical microphone device in this invention is explained. A diaphragm of the optical microphone device is actuated in accordance with the principle of the microphone called velocity type microphone. Now, a microphone that causes an output voltage in proportion to a difference in sound pressure between two adjacent points is presumed. As shown in FIG. 4, an object A may move along the axis y which crosses by an included angle θ with the direction x of the sound. The difference in force to function in both end faces, namely, the driving force F to the object A in the direction of axis y is shown by an expression:

\dot{F}=jωροS d cosθ\dot{u} (1)

In the above, S is the area of the end face vertical to the axis y of this physical object A,

d is a distance between both end faces,

ω is an angular frequency of the sound wave,

ρο is the air pressure, and

u is the grain density of the air.

Velocity V in the axis direction is shown by an expression:

$$\dot{V} - \dot{F} / \dot{Z} m = \frac{{jωρ}_{0} Sd cos θ}{\dot{Z} m} \cdot \dot{u} \qquad ( 2 )$$

In the above, Zm is the mechanical impedance of this object A.

Therefore, the velocity V in the axis direction of the velocity type microphone is in proportion to the particle velocity, the frequency and the area of the diaphragm. Further, it is inversely proportional to the mechanical impedance of the diaphragm. An optical microphone is structured to make the light emitted from the light source put on the diaphragm and to detect the reflection light. Therefore, the output voltage of the microphone is in proportion to the amplitude of the diaphragm (displacement) X.

Therefore, an equation (3) is concluded.

$$\dot{X} = \frac{\dot{V}}{i ω} = \frac{{ρ}_{0} Sd cos θ}{\dot{Z} m} \dot{u} \qquad ( 3 )$$

An amplitude of the diaphragm of the optical microphone becomes biggest when the direction of the sound is the same as the direction of the moving axis of the diaphragm (θ=0, 180 [deg]), and the amplitude becomes smallest when the both directions are right-angled (θ=90, 270 [deg]). Because the amplitude of the diaphragm is in proportion to the sensitivity, the directional characteristics to show the sensitivity is shown in FIG. 5.

Thus, an equation (4) is concluded.

$$\dot{X} = \frac{{ρ}_{0} Sd cos θ}{\dot{Z} m} \frac{\dot{P}}{{ρ}_{0} c} = \frac{Sd cos θ}{c \dot{Z} m} \dot{P} \qquad ( 4 )$$

In the above, P is the sound pressure of the diaphragm and c is sonic velocity.

An amplitude sensitivity toward the sound pressure is shown in the expression (5).

$$\frac{\dot{X}}{\dot{P}} = \frac{Sd cos θ}{c \dot{Z} m} \qquad ( 5 )$$

As explained above, the sensitivity of the optical microphone is in proportion to the area of the diaphragm and inversely proportional to the mechanical impedance of the diaphragm. The sensitivity is highest when the direction of the diaphragm oscillation and the direction of the sound is the same, and lowest when they are right-angled. When the mechanical impedance of the diaphragm is resistance (the rheostatic control state that acoustic resistance and so on is put on both sides of the diaphragm), sensitivity becomes unrelated value to the frequency. However, when the diaphragm is strained (stiffness control), a sensitivity rises in proportion to the frequency as much as high band. Conversely, when a diaphragm is made loose (the inertia control), a sensitivity falls down as much as high band, because the sensitivity is inversely proportional to the frequency. In the stiffness control and the inertia control, sensitivity depends on frequency and electric correction becomes necessary.

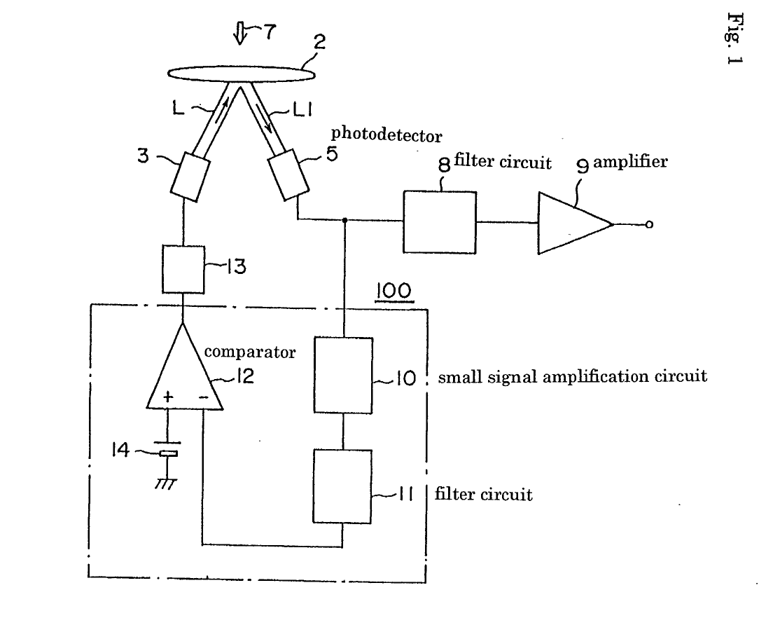

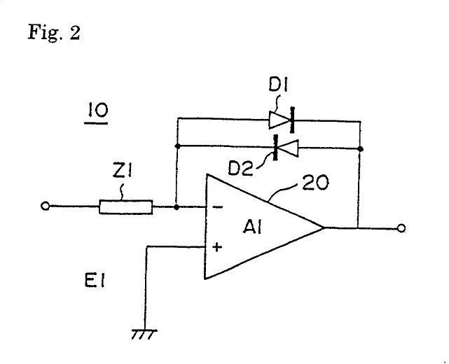

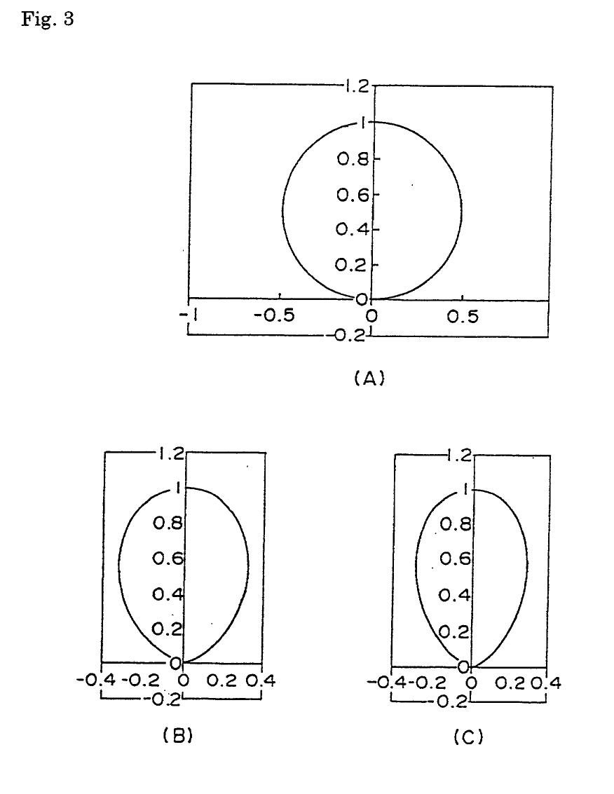

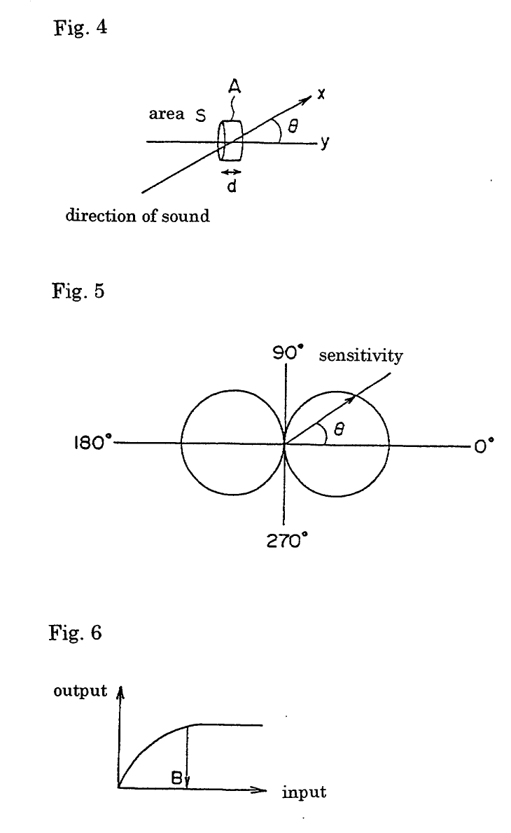

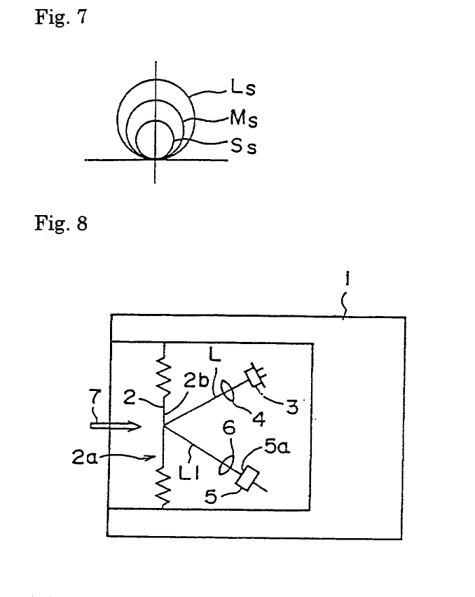

In the optical microphone device, the sensitivity toward the sound wave shows a fixed directivity response pattern as shown in FIG. 5. In the optical microphone device of this invention, the directivity response pattern of a sensitivity shown in FIG. 5 is made to stretch along with the axis direction of θ=0, 180 [deg], and to be narrowed in the direction of θ=90, 270 [deg] which is vertical to the axis. FIG. 1 is a block diagram that shows one embodiment of the optical microphone device of this invention. The same code is put to the same part with the conventional device shown in FIG. 8, and the detailed explanation is omitted.

Because the structure of the microphone head part is the same as the structure shown in FIG. 8, only the part relating to this invention is shown in FIG. 1. An output from the photodetector 5 is taken out through a filter circuit 8, amplified by an amplifier 9, and it becomes microphone output. The filter circuit 8 is used to take out a requested signal component of the frequency range.

In the optical microphone device of this invention, it is composed to supply a part of the output signal from this photodetector 5 to a light source drive circuit 13 through a negative feedback (NFB) circuit 100 as a negative feedback signal. The light source drive circuit 13 drives this light source 3 by supplying predetermined electric current to the light source 3. The negative feedback circuit 100 comprises a small signal amplification circuit 10, a filter circuit 11 which takes out a signal component of the requested frequency range from the output from the small signal amplification circuit 10, and a comparator 12. A norm power source 14 that provides reference voltage is connected to the non-inversion-input terminal of the comparator 12.

The signal taken out through the filter circuit 11 is supplied to the reverse input terminal of the comparator 12. Only when an input signal level is less than a predetermined level, the small signal amplification circuit 10 amplifies that signal. When it is composed like this, a low output level is outputted as much as the output of the filter circuit 11 of the comparator 12 is big, and the light source drive circuit 13 is actuated by this to reduce electric current supplied to the light source 3. As the light source 3, LED may also be used in place of the laser diode. The lens 4,6 can be omitted when the lens is also built in the laser diode or LED.

Next, the circuit actuation of FIG. 1 is explained below. FIG. 6 is to explain the circuit actuation of the small signal amplification circuit 10. The small signal amplification circuit 10 amplifies an input signal only when the input signal level is less than a predetermined level. In FIG. 6, when the input signal level is beyond the B point, an output signal level doesn't vary from the input signal level, and amplification degree (gain) becomes 0. When the input signal level is not more than the B point, the small signal amplification circuit 10 amplifies the input signal so that amplification degree may grow high as much as the input signal level is small.

As shown in FIG. 6, the rate of increase of the output signal against the input signal rises as much as the input signal level is small. Here, as the output from the photodetector 5 is in proportion to the reception sound volume, the output of the small signal amplification circuit 10 is greatly amplified as much as small sound volume. As the output of the small signal amplification circuit 10 is inputted to the reverse input terminal of the comparator 12 via the filter circuit 11, the output level of the comparator 12 decreases conversely as much as small sound volume. As a result, the electric current supplied to the light source 3 declines as much as small sound volume. Id est, it is decided as much as small sound volume that the sensitivity of the microphone declines.

As a signal beyond the predetermined level is not amplified, an optical output isn't restricted at the predetermined level. Therefore the sensitivity of the microphone never declines. As a result, the directivity response pattern of the sensitivity when loudness was changed is shown in FIG. 7. In this figure, Ss shows small sound, Ms shows middle sound, and Ls shows big sound. Therefore, microphone sensitivity doesn't change toward a sound beyond the predetermined level. Under the predetermined level, as the level of the sound falls down, the sensitivity of the microphone becomes low.

When the sound which came from the axis direction which is vertical to the diaphragm and which has a volume that does not cause the sensitivity decline of the microphone is moved from the axis direction, a sensitivity gradually declines along the original directivity response pattern curve. Then, when the sensitivity becomes less than a certain level, small signal amplification circuit 10 comes to have amplification degree, and the electric current control of the light source drive circuit 13 works, and the sensitivity of the microphone declines more. As this result, with the optical microphone device that has negative feedback circuit 100, the width of the directivity beam is more limited than the directivity response pattern of the sensitivity as shown in FIG. 5. Here, a gain of negative feedback grows big by enlarging the amplification degree of the small signal amplification circuit 10, and the electric current restraint of the light source 3 works toward the small sound so that a directivity response pattern may become limited more.

FIG. 3 shows an example which made the pattern of the directivity change by making a gain of negative feedback change. FIG. 3A shows the directivity response pattern when negative feedback wasn't made. It almost becomes a circular directivity response pattern in this case. Next, the directivity response pattern in which a negative feedback is made is shown in FIG. 3B and 3C. A gain of negative feedback is small in FIG. 3B, and a gain of negative feedback is big in FIG. 3C. As shown in these figures, the gain of negative feedback is made to change by varying the amplification degree of the small signal amplification circuit 10. The directivity response pattern of the sensitivity can be stretched along the axis direction of the optimum sensitivity by this, or narrowed in the direction that is vertical to the axis. Also, by changing the point B to begin the amplification by the small signal amplification circuit 10 shown in FIG. 6, the directivity response pattern can be changed. This is because the point, where the sensitivity of the directivity response pattern declines, is changed. By doing like this, the directional characteristics of the sensitivity of the optical microphone may be changed.

FIG. 2 is a circuit diagram which shows an example of the small signal amplification circuit 10. Two diodes D1 and D2 in multiple connection are provided in opposite directions to each other between the reverse input terminal and the output terminal of the amplifier 20. A non-reverse input terminal of the amplifier 20 is grounded. Input is connected to the reverse input terminal of the amplifier 20 via impedance Z1.

In this structure, assuming the impedance of the diode D1, D2 is Zd, the gain A1 of the amplifier 20 is shown in the expression (6).

A1=Zd/Z1 (6)

The impedance Zd is the impedance of the diode. Therefore, if the potential between the both ends of the impedance Zd exceeds the threshold voltage of the diode, the impedance becomes extremely small, and thus the gain A1 almost becomes 0 by that signal beyond the level.

A1=0 (7)

If the potential difference between the both ends of the impedance Zd is no more than the above level, the internal impedance of the diode become high, and the internal impedance still grows higher as much as the potential difference between the both ends is low. Therefore, the gain Al grows higher in accordance with the expression (6) as much as output voltage is small. When the output becomes beyond a predetermined level (beyond the threshold voltage of the diode), the gain disappears, and an output may not become higher. Therefore, amplification degree (gain) can be changed by changing the impedance Z1 connected to the reverse input terminal.

Also, the output level that amplification degree becomes 0 can be varied by changing the types of the diode D1, D2. For example, a silicon diode may achieve the level of 0.6[V], and a Ge diode may achieve the level of 0.2-0.3[V]. A Schottky diode may achieve the level about 0.3[V].

To explain the actuation principle of this invention, as a configuration of the head portion of the optical microphone device, the structure that a sound wave enters from only one side of the diaphragm 2 was disclosed. However, in the practical viewpoint, a structure that a sound wave may enter from both sides of the diaphragm 2 is preferable. In the small, velocity type optical microphone, it is preferable that the diaphragm 2 may freely oscillate inside the head 1 by the sound wave. If a block side exists adjacent to the diaphragm 2 and a sound wave doesn't enter, the oscillation of the diaphragm 2 is obstructed, and the directional characteristics don't become the pattern forms stated before but become undirectional in some cases. With the optical microphone device which set up a diaphragm 2 in the center of the head 1 so that a sound wave might enter uniformly from both sides, a directivity response pattern shown in FIG. 3 and FIG. 7 appears in the symmetry on the opposition side as well to show the “8” character characteristics.

As explained above, with the optical microphone device of this invention, a part of the output signal from the photodetector is negatively feedbacked to the light source drive circuit through the negative feedback circuit. Therefore, in the small signal level, negative feedback becomes strong and the electric current to the light source becomes small and the sensitivity declines. Therefore, the directivity response pattern of the sensitivity becomes a narrowed pattern more than an original directivity response pattern. Therefore, the directional characteristics of the optical microphone becomes sharp and the sound wave of the specific direction can be received. Therefore, there is an advantage that off site noise can be restrained.

What is claimed is:

1. An optical microphone device comprising:
a diaphragm which oscillates by a sound pressure;
a light source that irradiates a light beam in the diaphragm;
a photo detector which receives a reflection light of the light beam irradiated in the diaphragm and which outputs a signal coping with the oscillation of the diaphragm;
a light source drive circuit for driving to supply the light source with a predetermined electric current; and
a negative feedback circuit that supplies a part of the signal outputted from the photodetector with the light source drive circuit as a negative feedback signal.

2. The optical microphone device according to claim 1, wherein the negative feedback circuit comprises:
a comparator that an output terminal is connected to a control terminal of the light source drive circuit and that a non-reverse input terminal is connected to a predetermined potential point; and
a small signal amplification circuit that amplifies the signal from the photodetector when the signal level is less than a predetermined level, and the amplification degree grows bigger along with the signal level becomes smaller; and
wherein the output of the small signal amplification circuit is supplied to the reverse input terminal of the comparator.

3. The optical microphone device according to claim 2,
wherein the output of the small signal amplification circuit is supplied to the reverse input terminal of the comparator through a filter circuit that allows the output in a predetermined frequency range to pass.

4. The optical microphone device according to any one of claims 1-3, further comprises a gain of negative feedback variable means that varies the gain of negative feedback of the above negative feedback signal.
